(19) United States
(12) Patent Application Publication
(10) Pub. No.: US 2009/0229444 A1
(43) Pub. Date: Sep. 17, 2009

(54) Pedal operated snare drum stand

(76) Inventor: Daniel Christopher Measelle, Jupiter, FL (US)

Correspondence Address: Daniel C. Measelle, 5820 Our Robbies Rd., Jupiter, FL, 33458, US

(21) Appl. No.: 12/077,025

(22) Filed: Mar. 17, 2008

(51) Int. Cl. G10D 13/02

(52) U.S. Cl. 84/421; 84/422.1

(57) ABSTRACT

A snare stand having a unit slidaby mounted in the center post for protraction and retraction therefrom by a push pedal actuated protract-retract mechanism. The end of the unit arm connect to any make snare drum by a universally adjustable throw-off plate that replaces the factory plate used to hold the snare ribbon in place, allowing the user to quickly raise and lower the snare ribbon with a push of a pedal. The mechanism operates in such a way that when the pedal is pressed down the snare ribbon with either raise or lower, and remain in that position until the pedal is pressed again.

### SUMMARY OF THE THE INVENTION

The basic object of the present invention is to improve the operability of the snare drum and snare drum stand.

In accordance with the present invention, a mechanism used to raise and lower the snare ribbon is placed within the stand's center post and operated by a pedal conveniently positioned under the stand.

### BRIEF DESCRIPTION OF DRAWINGS

FIG. 1. Is a perspective plan view of one embodiment of a snare drum stand with the pedal operated snare drum lever.

FIG. 2. Is a sectional view of the stand's center post (5) connected to the slidable unit (1a)

FIG. 3. Is a sectional view of the push button member (4a), its internal spring (4e) and the lug member (4b)

FIG. 4. Is a perspective view of the throw-off plate (2) to which the unit arm connects.

FIG. 5. Is a perspective view of the operating pedal, its base (3a), foot switch (3b), push button connector (3d) and “mouse trap” spring (3c).

FIG. 6. Show the “mouse trap” spring mechanism (3c) used to keep the foot switch (3b) in the raised position.

Corresponding reference characters indicate corresponding parts throughout the several views of the drawings.

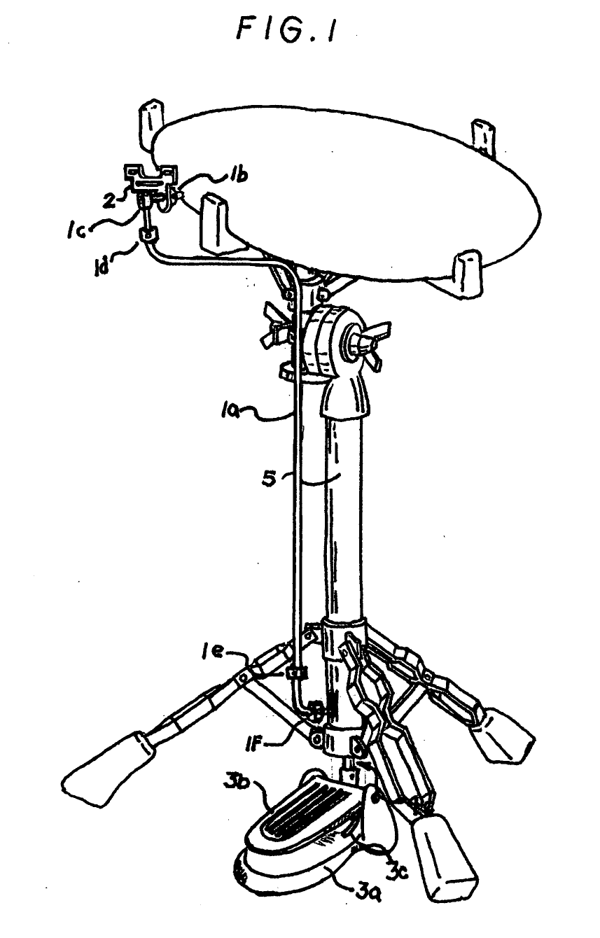

In FIG. 1. a snare drum stand complete with the pedal operated snare drum level in accordance with the present invention includes a hollow upright center post(5) holding the protract-retract mechanism and the slidable arm unit (1a) which exits through a slot in the side of the post. The slidable arm unit is separated in parts by adjustable collars (1b),(1c),(1d),(1e),(1f) which allow the unit arm to be adjusted to fit properly with any application. Adjustment collar 1b sits in back of the adjustable throw-off plate (2) preventing the plate from sliding free from the arm unit. (1c) allows for the horizontal adjustment of the unit arm in proximity to the throw-off plate(2). (1d) allows the for horizontal rotation adjustment at the top of the unit arm, also allowing for vertical adjustment in proximity to the throw off plate (2). (1e) allows for further vertical adjustment and rotational adjustment towards the base of the unit. (1f) allows the unit arm to be easily connected and disconnected from the internal protract-retract mechanism, while also allowing for vertical rotation adjustment as well as addition horizontal adjustment. The unit arm (1a), formed in such a way to avoid any and all clearance issues, connects to a n adjustable throw-off plate (2) that is used to replace the small factory plate, which holds the snare ribbon to the snare throw-off lever. The throw-off plate (2) comprises of two parts (2a) and (2b). Also in FIG. 1., in accordance with the present invention includes the push button member (4a) exiting through the bottom of the stand's hollow center post(5) connected to the push button connector (3d) part of the operating pedal(3). The pedal is comprised of pieces: (3b) the foot switch incorporated with a “mouse trap” spring (3c) as to keep the foot switch (3b) in the raised position, and (3a) the pedal base.

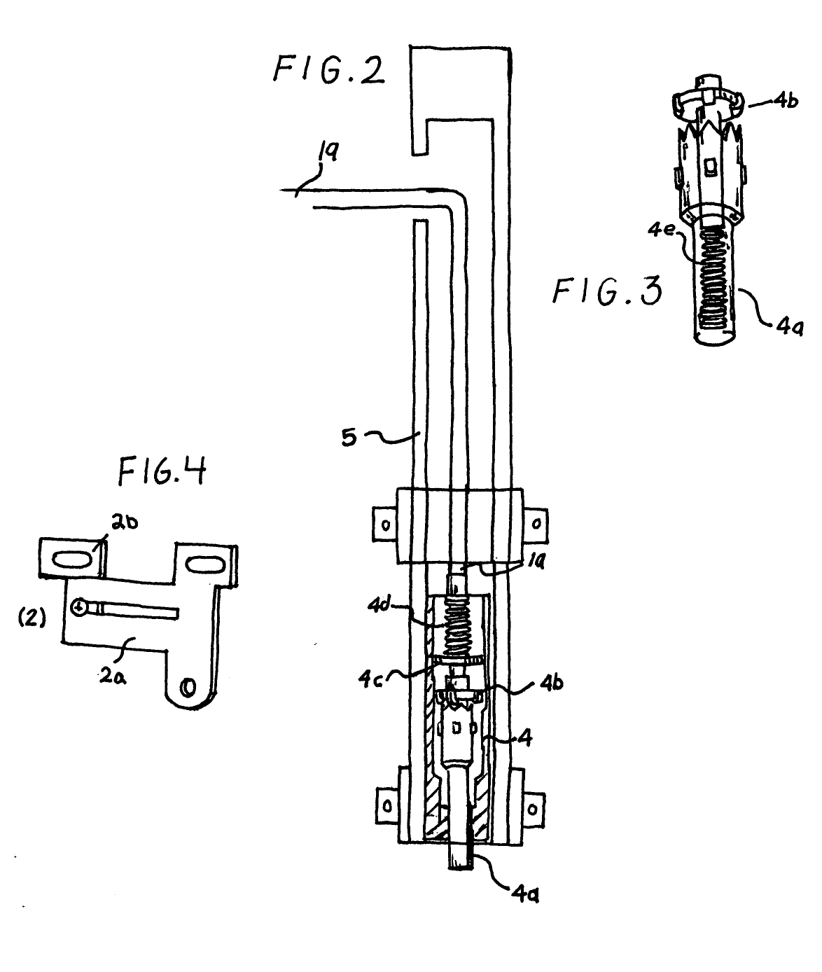

FIG. 2. shows a sectional view of the hollow center post (5) and it's components. Firstly, the protract-retract mechanism (4) which incorporates the push button member ( 4a) comprising of a hollow base portion having 8 teeth extending from the end thereof and a stem extending from the opposite end thereof. Four stub projections (4f) are formed on the periphery of the base portion, spaced from, yet longitudinally aligned with the respective teeth, which fit into grooves cut into the mechanism's (4) casement. The push button mechanism, the lug member (4b) including the spring (4d) the casement slots etc. work in a known manner identical to a retractable pen. The unit arm (1a) when activated by the protract-retract mechanism (4) either protracts or retracts inside the hollow center post (5) and allowed an exit from the post at a 90 degree angle through a slot cut into the side of the post. When the unit arm (1a) is moved either up or down by the mechanism the snare ribbon will move either up or down in conjunction.

FIG. 3. is a sectional view of the push button member (4a), and the lug member (4b), and shows how the lug member's stem slides into the hollow stem of the push button member where fitted inside is a spring (4e) that allows the push button member to remain in the down position and connected to the push button connector whether the unit is protracted or retracted.

FIG. 4. is a drawing of the throw-off plate (2), that replaces the plate found of factory snare throw-offs used to hold the snare ribbon in place by means of squeezing it against the throw-off lever. This plate plate works in the same fashion with exception to its adjustability. The throw-off plate comprises of two piece 2a and 2b. Part 2a contains three holes one round hole cut into an extension at the button of the plate whereby the slidable unit arm (1a) connects, a universally slotted hole at top whereby the plate connects to any factory snare throw-off, and a long slot in the center, which allows horizontal adjustment by a set screw in conjunction with part 2b. Part 2b contains 2 holes, 1 universally slotted hole at top whereby the plate connects to any factory snare throw-off and a round hole near the center whereby it connects to part 2a via the universal slot and set screw.

FIG. 5. is a perspective drawing of the pedal used to actuate the protract-retract mechanism. This part is comprised of four pieces: the pedal base (3a), which (3a) by way of the uprights arms is attached the foot switch (3b) fitted with a small cup complete with a set screw here called the push button connector (3d) used to push the push button member (4a) upward to activate the protract-retract mechanism (4). The foot switch (3b) is connected to the base by a pin enclosed in a “mouse trap” spring (3c) which connects to each upright arm of the pedal base.

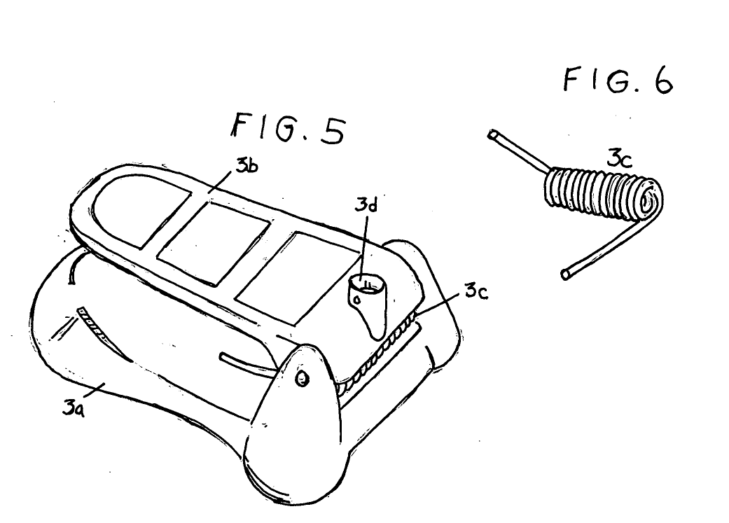

FIG. 6. shows a common “mouse trap” spring (3c). The spring here will be used to keep the foot switch in the raised position, regardless if the unit is protracted or retracted. This allows the user to have immediate control of the pedal's functions.

I claim:

1. A snare drum stand containing a unit internally mounted which raises and lowers the snares of a snare drum by way of a pedal operated protract-retract mechanism.

2. A snare drum stand as described in claim 1 including: a protract-retract mechanism mounted inside a snare drum stand's hollow center up-right post.

3. A snare drum stand as described in claim 1 including: A pedal placed under the stand, which connects to and operates the protract-retract mechanism.

4. A snare drum stand as described in claim 1 including: A fully adjustable, slidable unit arm that attaches at one side to the protract-retract mechanism and at the other side to any make snare drum throw-off by way of a universal throw-off plate.

5. A snare drum stand as described in claim 1 including: With improved functionality of the tradition snare drum throw-off lever by connection to a pedal operated protract-retract mechanism.

6. A snare drum stand as described in claim 1 including: A new use for a traditional protract-retract mechanism by use in the center post of a snare drum stand in order to raise and lower the snare ribbon by way of a slidable arm.

7. A snare drum stand as described in claim 1 including: Improved functionality and practicality over any other possible designs for pedal operated drum snares by making use of a protract-retract mechanism allowing the snare ribbon, once the pedal is pressed, to remain either up or down without further human assistance, depending on if the mechanism is either protracted or retracted, until the pedal is pressed again.

8. A snare drum stand as described in claim 1 including: Improved functionality and practicality over any other possible designs for pedal operated drum snares by allowing, in addition to the matter outlined in claim 6, the user to, with less pressure on the pedal when pressed, control the snare either up or down manually by pedal without making use of the protract-retract mechanism.

9. A snare drum stand as described in claim 1 including: A fully adjustable and universal unit arm and throw-off connection plate, allowing the system to work with any make snare drum.

10. Drums snares operated by pedal, which remain in the lowered or raised position until the pedal is pressed, allowing the player to quickly and easily activate their snare throw-off lever by foot while playing, changing the tone of their snare drum, at their leisure.
